(19) United States
(12) Patent Application Publication
(10) Pub. No.: US 2013/0018512 A1
(43) Pub. Date: Jan. 17, 2013

(54) Method for Controlling or Regulating a Machine

(71) Applicant: Ralf Otte, Weinheim (DE)

(72) Inventor: Ralf Otte, Weinheim (DE)

(73) Assignee: tecData AG, Uzwil (CH)

(21) Appl. No.: 13/636,731

(22) PCT Filed: Mar. 24, 2011
(86) PCT No.: PCT/EP2011/054507

§ 371 Date: Sep. 24, 2012

(30) Foreign Application Priority Data
Mar. 24, 2010 (EP) 10157618.9

(51) Int. Cl. G05B 19/04

(52) U.S. Cl. 700/275

(57) ABSTRACT

The invention relates to a contactless man/machine interface and to an appropriate method for controlling or regulating a machine. The interface comprises a first signal generator, which is equipped with at least one component that has a noise signal. By means of calibration according to the invention, it is possible to use the signal for controlling or regulating a machine.

The present invention relates to the technical field of controlling and/or regulating machines, in particular by means of a contactless man-machine interface.

It is known that voltage fluctuations can be tapped off and recorded on the surface of a person's head; the method is known as electroencephalography (EEG). The different frequency bands of EEG may be associated with different states of the subject; the frequency bands extend from the delta frequency band (approximately 0.5-3.5 Hz in deep sleep/trance) to the gamma frequency band (approximately 38-70 Hz during challenging activities with a large flow of information). EEG is traditionally evaluated by means of pattern recognition by the trained evaluator.

It is likewise known that signals from the deeper brain, which would otherwise be lost in the noise caused by other parts of the brain, can be filtered out by means of so-called averaging of conventionally recorded EEG signals. A special use is, for example, the detection of responses of the brain stem to stimuli. Signals from the cortex would usually be superimposed on such responses of the brain stem in EEG. However, the signals from the cortex can be largely averaged out, by averaging the signals, in such a manner that weak signals from the brain stem can also be detected. In medicine, use is made in this case of the temporal shift in characteristic peaks which were obtained from subjects with healthy stimulus conduction and processing in the brain stem. A significant shift in this peak is used as an indication of a brain tumor, for example; also see, in this respect, Ralf Otte, “Untersuchung von Artefakten bei der Messung von akustisch evozierten Hirnstammpostentialen” [Study of artefacts when measuring acoustically evoked brain stem potentials], thesis, page 15 ff., Technical University of Berlin, Institute for Control Engineering and System Dynamics in cooperation with the Technical University of Chemnitz, Institute for Information Technology; and U. Kischka, C. Wallesch, G. Wolf, “Methoden der Gehirnforschung” [Brain research methods], Spektrum Akademischer Verlag, 1997, page 171 ff.

Recent, non-medical applications of EEG are aimed at controlling computers by means of cognitive processes. Successes have been reported, whereby a mouse cursor can be moved in a very precise manner after a learning phase with the aid of EEG.

In the meantime, such brain-computer interfaces (BCI) using EEG have already made inroads into medical practice and are used by severely handicapped persons to communicate with the outside world. This is possible as a result of the fact that the subjects' thoughts can be recognized using pattern recognition downstream of conventional EEG or can be classified at least into existing classes, for example “0” vs. “1”, “to the left” vs. “to the right” or “yes” vs. “no”.

Since 2008, the company OCZ Technology has been selling a so-called NIA (Neural Impulse Actuator) with which EEG technology has in the meantime also been used in the computer games market; in this case, symbols on a computer screen are manipulated using subjects' thoughts and their real-time EEG evaluation.

In all of the abovementioned uses based on conventional EEG, the absolutely necessary, direct contact of electrodes with the surface of the person's head is disadvantageous. A contactless variant (for example of the NIA from OCZ) which can thus distinguish and process at least simple commands, such as “to the left”/“to the right”, is not known.

Therefore, an object of the present invention is to provide a contactless man-machine interface and a corresponding method for controlling or regulating a machine in order to facilitate communication with severely disabled persons, for example, or to implement novel safety or computer games applications.

The object is achieved, according to the invention, by a method for controlling or regulating a machine by means of a contactless man-machine interface, comprising the steps of:

a) providing a first signal generator which is provided with at least one component having a noise signal (this component is preferably a semiconductor component, in particular a semiconductor diode or a transistor);

b) providing a data record containing commands for controlling a machine;

c) optionally gathering calibration data by
ca) arranging the first signal generator and a person in spatial proximity;
cb) repeatedly recording the noise signal from the first signal generator on the basis of a thought which is predefined to the person, the thought being selected from the elements in the data record according to b);
   (The repeated recording is preferably carried out 30 to 100 times; this has proved to be sufficient for calibration at the lower end of the range and has proved to be particularly advantageous for the calibration quality in the upper range. The repeated recording is also carried out at randomly predefined times, as a result of which conditioning of the person and other external interference can be excluded.)
cc) averaging the noise signals obtained according to cb) for the individual predefined thoughts;
   (Before averaging, the analog noise signals are preferably also amplified (for example with a gain factor in the range of approximately 10 to approximately 100) using measures known per se, discretized (for example with 8 or 16 bits) and sampled (for example at 1000 Hz, as a result of which the signal sampling distance theorem is satisfied since brain waves up to a maximum of 100 Hz are detected within the scope of the invention).)
cd) mathematically processing the noise signal(s) averaged according to cc), if necessary;
ce) storing the noise signals obtained according to cc) and/or the data derived therefrom according to cd) in a manner associated with elements in the data record;
cf) repeating method steps cb)-ce), if necessary, and storing a plurality of noise signals obtained according to cc) and/or the data derived therefrom according to cd) in a manner associated with elements in the data record, with the result that a plurality of noise signals or data derived therefrom are respectively stored for an element in the data record;
   (Method steps cb)-ce) can typically be repeated approximately 1-10 times, which has proved to be advantageous for the calibration quality. The calibration quality increases with the number of repetitions.)

d) controlling or regulating a machine, in particular using the calibration data gathered according to c), by
da) repeatedly recording the noise signal from the first signal generator on the basis of a thought which is not predefined to the person (but rather is freely selected by the latter at a particular time) and is selected from the elements in the data record according to b);
   (A repetition frequency with which the noise signal is recorded and which substantially corresponds to the frequency selected in step cb) is advantageously selected; as a result, the useful signal is singled out particularly well from the noise signal and can be compared with the signals obtained with step cb).)
db) averaging the noise signals obtained according to da) for the thoughts which have not been predefined;
   (Before averaging, the analog noise signals are preferably also amplified (for example with a gain factor in the range of approximately 10 to approximately 100) using measures known per se, discretized (for example with 8 or 16 bits) and sampled (for example at 1000 Hz, as a result of which the signal sampling distance theorem is satisfied since brain waves up to a maximum of 100 Hz are detected within the scope of the invention).)
dc) mathematically processing the noise signal(s) averaged according to db), if necessary;
dd) associating the noise signal(s) obtained according to dc) with a thought in the data record, in particular on the basis of a comparison with the calibration data gathered according to c) and/or predefined reference data.
   (As an alternative or possibly also in addition to the calibration data, it is possible to provide reference data which were obtained, for example, from previous calibrations or else from data collections of empirical values, in particular other calibrations. However, it has been shown in previous experiments that, in particular, real-time calibration with the aid of the subject himself provides the best results.)

In particularly preferred embodiments, the noise signal from the signal generator is shot noise or avalanche noise.

Shot noise is the form of noise which occurs when an electrical current must overcome a potential barrier. This shot noise is usually represented as the noise current squared according to I_{R}²=2*e*I*Δf (I_{R}², averaged noise current squared; e, elementary charge; I, flowing current; Δf, measurement bandwidth). Typical examples of the occurrence of shot noise are, in particular, reverse currents in diodes and transistors; photocurrent and dark current in photodiodes and vacuum photocells; anode current of high-vacuum tubes.

Avalanche noise occurs, for example, in zener diodes in the case of pn junctions operated above their reverse voltage or else in gas discharge tubes or avalanche transistors.

Within the scope of the invention, the use of the shot noise of zener diodes as the noise signal from the signal generator is particularly preferred.

The data record which is provided in step b) and contains commands for controlling a machine preferably contains elements selected from the group consisting of “yes”, “no”, “to the left”, “to the right”, “at the top”, “up”, “at the bottom”, “down”, “at the front”, “forward”, “at the rear”, “backward”. The data record very particularly preferably consists of pairs, in particular opposing pairs, of such elements; in particular “to the left”/“to the right”; “at the top”/“at the bottom”; “up”/“down”;“at the front”/“at the rear”; “forward”/“backward”; “yes”/“no”.

In preferred embodiments of the invention, the signal generator and the person are arranged in step ca) at a distance of >1 cm, preferably of >50 cm, particularly preferably of >1 m. A particularly convenient man-machine interface can be implemented, in particular with the greater distances.

In further particularly preferred embodiments, the noise signal from the first signal generator is recorded on the basis of a thought predefined to the person in step cb) over a predefined period of time after the thought has been predefined, in particular over the period of time of 0 to 1 s, preferably over the period of time of 0 to 500 ms after the thought has been predefined. This makes it possible to ensure that the recorded signal respectively contains the signal caused by the thought. Occasionally suitable adaptation of the suitable interval of time can be easily determined by a person skilled in the art. The period of time of 0 to 500 ms after the thought has been predefined has generally proved to be favorable. This has proved to be advantageous for filtering out the desired information for the following reasons: the received EEG signals are firstly very weak (they fall with the square of the distance between the receiver (the signal generator) and the brain) and are secondly in wavelength ranges in which interference signals from the environment are also present; the signal-to-noise ratio is approximately 1:1000 or less. An important challenge of the invention is therefore the filtering of the useful signals needed to control or regulate the machine. This is achieved, according to the invention, by detecting the signal during calibration at suitably selected intervals of time after a thought has been predefined to the person. This may be effected, for example, by pulling out a card on which “to the left” or “to the right” is written. If the signal is detected at these random but defined (by the pulling-out of said card in the example) times, all external interference signals as well as other brain signals, also from persons in the vicinity, are averaged to zero by the above-described calibration principle at random times, as described above. However, the signals recorded after a thought has been predefined to the person also contain the signals characteristic of these stimuli; these remain when averaging the signals, as described above, since they are precisely not random but rather were initiated at a defined time by the predefinition of a thought and are deterministic; these signals are not averaged to zero. A characteristic signal is thus obtained in an amazingly simple manner, for example for “to the right” or “to the left”.

It has been found that the calibration data relating to different subjects are very often not the same since each subject indeed generates a characteristic signal for the uncertain thoughts from the data record b) (which layers of the brain are responsible therefore is not important for the present invention since the signals from other subjects also differ with the same stimulus; however, as a result of the above-described manner of calibration, it is not important to generally determine the characteristic signal response of the person's brain for certain thoughts (which is sought in medical uses of conventional averaging), but rather the individual signal from a user is determined by calibration and is used in further applications in order to control and regulate machines in comparison with the previously calibrated signals.

The mathematical processing of the averaged noise signal obtained in step cc) also preferably comprises representing the obtained curve as a multidimensional vector. In the case of a selected interval of time of 500 ms after the thought has been predefined and with sampling at 1000 Hz, the averaged noise signal from the first signal generator can be converted into a 500-dimensional vector, for example (one dimension for each millisecond; it goes without saying that other graduations are also possible). Conversion to a vector simplifies the mathematical processing of the (temporal) curve in the subsequent analysis.

In the simplest case, it could be expected that the reference signal remaining after averaging for a reference thought is always the same across all subjects or at least for each individual subject, with the result that the unknown averaged signal only has to be compared with the stored signal in the application phase. However, the applications show that the reference signals of a subject also fluctuate, with the result that it has proved to be particularly advantageous to determine and then use a plurality of reference signals for the same thought (cf. method step cf)). These reference signals (typically curves) are particularly preferably converted into reference vectors by means of mathematical processing, as described above. 10 reference signals or reference vectors for each reference thought have proved to be sufficient. 10 reference vectors are thus respectively stored for each reference thought; according to the abovementioned example, 10 500-dimensional reference vectors are stored for “to the left”, for example, and 10 500-dimensional reference vectors are stored for “to the right”, for example.

In the application phase (cf. da) to dd)) when the subject's thought is intended to be determined, a new comparison vector is created by averaging over a period of time of 30×500 milliseconds, for example (as described above using a reference vector). This vector is then compared with the stored reference vectors; cf. dd). This can be carried out in different ways which are familiar per se to a person skilled in the art; simple suitable possibilities for the comparison are, for example:

the Euclidean distance between the comparison vector and all stored reference vectors (the comparison vector is then allocated to the class corresponding to that of the reference vector with the shortest Euclidean distance); or

the scalar product of the comparison vector with all reference vectors (the comparison vector is then allocated to the class corresponding to that of the reference vector with which the comparison vector forms the largest scalar product).

After such a comparison has been carried out, the comparison vector is assigned to that class to which the vector with the shortest Euclidean distance belongs (for example one of the 10 reference vectors for the class “to the left”).

In further exemplary embodiments, in a departure from the comparison possibilities described above, the 3, 5 or 7 (etc.) reference vectors closest to the comparison vector in the vector space can be determined, for example; in this case, the measure “closest” can in turn be formed by means of suitable metrics (for example the Euclidean distance again). In this case, an uneven number of adjacent reference vectors are preferably analyzed, with the result that a clear assignment to a class can be carried out in such a manner that the mere number of closest reference vectors decides the assignment. When considering a plurality of reference vectors, however, it goes without saying that it is also possible to take into account both the number of adjacent reference vectors in a class and their respective distance from the comparison vector. In this case, a suitable weighting of the two parameters can also be determined, if appropriate, using routine experiments.

The methods described above are advantageous because they can be used to model arbitrarily complex class boundaries on account of the transformation of the curves into vectors since the vectors in the different classes need not be distributed in a well-organized manner in space but rather can be arranged in the vector space in an arbitrarily complex manner such that they are interleaved in one another. Regardless of how complex the interface between, for example, two classes is, there is always a reference vector which is closest to the comparison vector. This makes it possible to easily achieve sufficient accuracy with which the subject's thought is determined. If the assignment accuracy does not suffice in the individual case, the accuracy for separating the classes and thus the assignment accuracy can be increased, for example, by increasing the number of averaging operations (for example from 30 to 40 or else 100, see above); by increasing the number of reference vectors (for example from 10 to 20 for each class, see above); by changing the assignment metrics (for example distance dimensions of the fourth, sixth or eighth power may be used instead of the quadratic (Euclidean) distance). Although all of these possibilities result in increased computational complexity, they can otherwise be implemented by a person skilled in the art using routine measures.

Such usability of averaging was not expected; whereas, in medicine, a brain response which cannot be actively influenced by the subject (shift in a peak on account of a pathological change in the brain) is detected, the present invention deals with changes in the signals from the brain on account of a signal which can be influenced or is deliberately produced solely by the subject (thought). If necessary, a person skilled in the art would also have actually considered reference curves or the shift of characteristics of reference curves on the basis of the known medical use of averaging. In such a manner, it is not possible to distinguish elements in the data record for the present use.

Another aspect of the invention relates to a contactless man-machine interface, in particular for carrying out the method described above, the man-machine interface comprising:

at least one first signal generator which is provided with at least one component having a noise signal;

at least one calibration and evaluation unit comprising
at least one second signal generator which provides an optical, acoustic or haptic signal which can be perceived by the person;
at least one EDP system for
   gathering, processing and storing signals from the first signal generator;
   controlling or regulating a machine on the basis of signals from the first signal generator.

The invention is explained below using exemplary embodiments and figures without the subject matter of the invention being restricted to these embodiments. In the drawings:

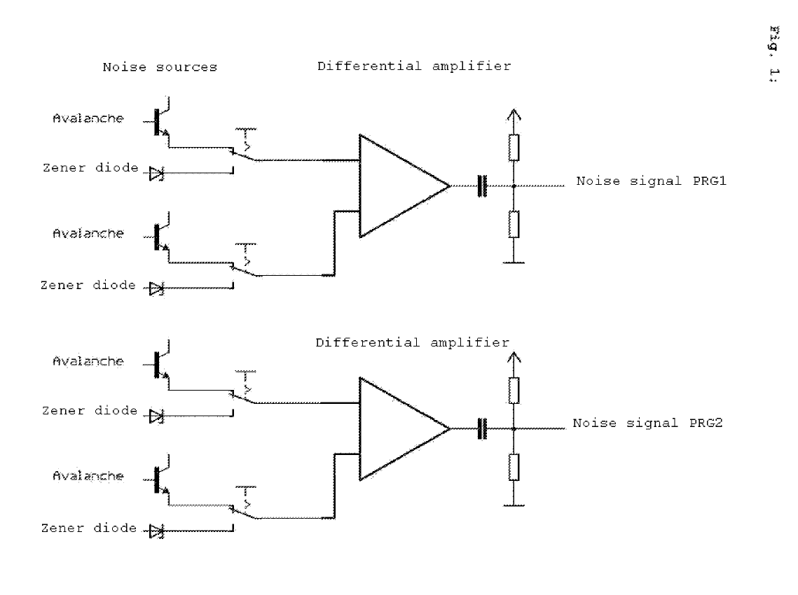

FIG. 1 shows a block diagram of a first signal generator;

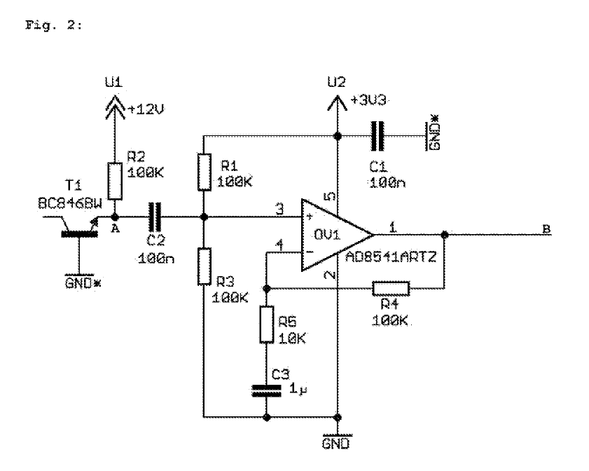

FIG. 2 shows a circuit diagram of a first signal generator;

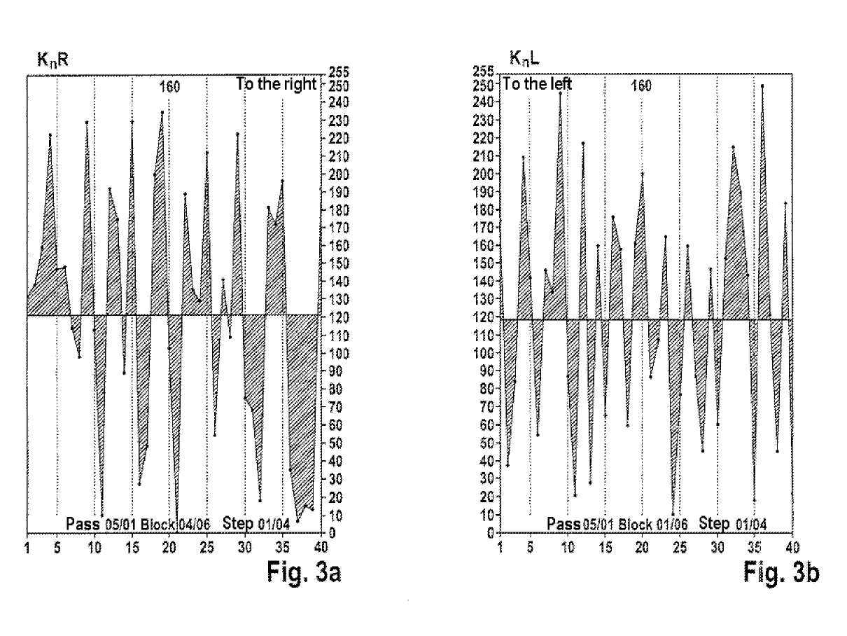

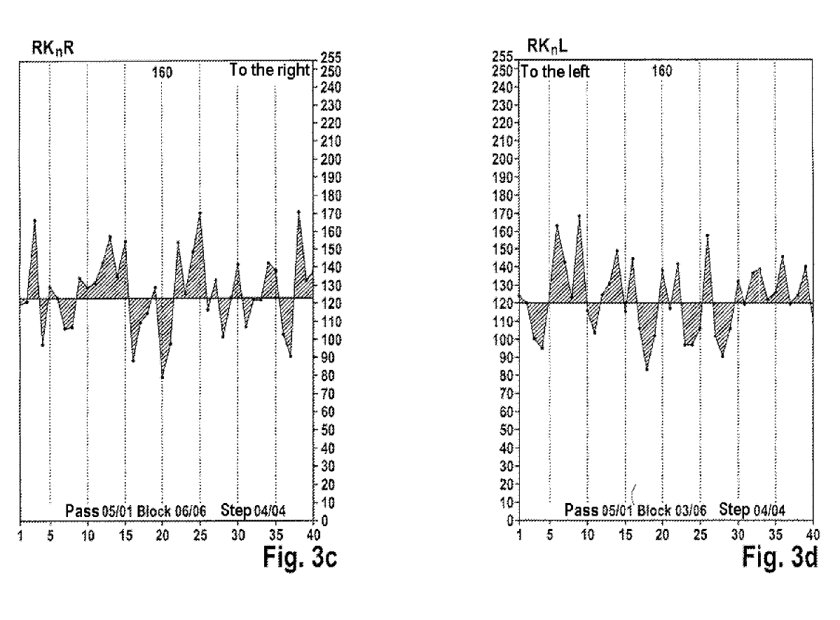

FIG. 3 shows an exemplary noise signal (oscilloscope plot, raw data) obtained at a distance of 10 cm from the subject's head during a random thought
a: “to the right” (individual measurement);
b: “to the left” (individual measurement);
c: “to the right” (after averaging);
d: “to the left” (after averaging).

The block diagram in FIG. 1 shows a first signal generator according to the invention in which it is possible to change over from an avalanche transistor to a zener diode. Two noise sources of this type are each operatively connected to a differential amplifier, thus resulting in a noise signal PRG1 and PRG2 which results from two avalanche transistors or two zener diodes.

FIG. 2 shows a circuit diagram of the first signal generator according to FIG. 1. The signal strength of the noise signal is approximately 200 mV at the point A in the circuit diagram; the signal strength of the output signal which is passed to an evaluation unit is approximately 2 V at the point B.

FIG. 3 shows a reference curve RKₙL, for “to the left” and RKₙR for “to the right”, as are typically obtained after 24 operations of averaging individual curves KₘL and KₘR (where m=1 to 24 for 24 averaging operations). 10 or more reference curves are advantageously recorded in each case; n=1 to 10 (or more). These reference curves RKnL and RKnR are each converted into a reference vector RVnL and RVnR, respectively. In the exemplary embodiment shown, one measured value was recorded every millisecond over a period of time of 400 ms; this results in a 400-dimensional vector during the conversion into a vector, as described above. Increased accuracy results, if desired, when the interval is reduced to below 1 ms, for example to 1 ms. In the exemplary embodiment shown, the noise signal was discretized with 8 bits (abscissa).

According to the invention, the following results were obtained in a test run with 60 subjects (28 male, 32 female; all between 18 and 40 years old):

Two different, completely separate computer systems were provided for the test run: one computer system for predefining the thoughts to the subjects and a further computer system for detection. In the calibration phase, the predefinition system simultaneously produces an acoustic signal and a visual signal for “to the left” or “to the right”. That is to say, in the case of “to the left”, an arrow moves to the left, for example, or an arrow appears in the left-hand field of a screen; an acoustic signal sounds at the same time as the optical signal appears. The EEG signals from the subject are detected by the separate recording system in a time window of 500 ms after the acoustic (and simultaneously visual) signal. The entire process was replicated three times for each request “to the left” and “to the right”, to be precise always at the time predefined with the acoustic and visual signals. Reference vectors for “to the right” and “to the left” are produced by averaging these three signals, as described above. This was repeated ten times in each case, with the result that ten reference vectors for “to the right” and ten reference vectors for “to the left” were ultimately obtained, as described above. In the calibration phase, the recording system also stores, as information, which signals are output in which order by the predefinition system; this is necessary in order to make it possible to associate the measurement data with the subject's thoughts as calibration data.

In the application phase, in contrast to the calibration phase, no information whatsoever relating to which signals are output in which order by the predefinition system is stored in the recording system. The combination of the acoustic and optical signals again appears three times in each case on the predefinition system. After the arrows, for example, have appeared, the signals from the subject are again recorded by the recording system within 500 ms in each case; a new comparison vector is created from these three signals, in a similar manner to that in calibration, by means of averaging, as described above. This comparison vector was then compared with the stored reference vectors. The comparison with the reference vectors was then used as a basis to determine, on the basis of the shortest distance to the reference vector in the Euclidean space, whether the subject has thought of “to the left” or “to the right”. The number of cases in which the system has correctly determined the subject's thought was then evaluated.

An expected value of 50% correct classification can be expected in this case by mere guessing. As the threshold value, a subject measurement was therefore defined as successful when the subject's thoughts were evaluated as 60% correct and only 40% since technically interesting applications can already be implemented in this case. The evaluation revealed that a correct classification of 60% was achieved in 14 of 60 subjects under the conditions mentioned above. The result across all subjects is statistically highly significant; the p-value is 0.004. The system therefore already meets industrial and scientific requirements since methods with a p-value of <0.05 (5%) can be considered to be statistically significant and can therefore be used.

The results also show that some subjects can be measured in an even much better manner with the method according to the invention, as described above. Subjects whose thoughts could be determined with much greater accuracy were thus determined in various other experiments. The p-value of these subjects from a one-sided binomial test was 0.00015 (and is thus extremely significant), with the result that they themselves are considered to be extremely suitable for the method according to the present invention after a Bonferroni correction of the number of all p-values, which correction is carried out by a person skilled in the art.

1-10. (canceled)

11. A method for controlling or regulating a machine by means of a contactless man-machine interface, comprising the steps of:
a) providing a first signal generator which is provided with at least one component having a noise signal;
b) providing a data record containing commands for controlling a machine;
c) optionally gathering calibration data by
ca) arranging the first signal generator and a person in spatial proximity;
cb) repeatedly recording the noise signal from the first signal generator on the basis of a thought which is predefined to the person, the thought being selected from the elements in the data record according to b);
cc) averaging the noise signals obtained according to cb) for the individual predefined thoughts;
cd) optionally: mathematically processing the noise signal(s) averaged according to cc);
ce) storing the noise signals obtained according to cc) and/or the data derived therefrom according to cd) in a manner associated with elements of the data record;
cf) repeating method steps cb)-ce), if necessary, and storing a plurality of noise signals obtained according to cc) and/or the data derived therefrom according to cd) in a manner associated with elements of the data record, with the result that a plurality of noise signals or data derived therefrom are respectively stored for an element of the data record;
d) controlling or regulating a machine, in particular using the calibration data gathered according to c), by
da) repeatedly recording the noise signal from the first signal generator on the basis of a thought which is not predefined to the person and is selected from the elements in the data record according to b);
db) averaging the noise signals obtained according to da) for the thoughts which have not been predefined;
dc) optionally: mathematically processing the noise signal(s) averaged according to db);
dd) associating the noise signal(s) obtained according to dc) with a thought in the data record, in particular on the basis of a comparison with the calibration data gathered according to c) and/or predefined reference data.

12. The method as claimed in claim 11, wherein the noise signal is shot noise or avalanche noise.

13. The method as claimed in claim 11, wherein a first receiver, as that component which has a noise signal, contains a component selected from the group consisting of diodes, in particular zener diodes operated above their reverse voltage; gas discharge tubes; avalanche transistors.

14. The method as claimed in claim 11, wherein the data record which is provided in step b) contains commands for controlling a machine selected from the group consisting of “to the left”, “to the right”, “at the top”, “up”, “at the bottom”, “down”, “at the front”, “forward”, “at the rear”, “backward”.

15. The method as claimed in claim 11, wherein the signal generator and the person are arranged in step ca) and/or da) at a distance of >1 cm.

16. The method as claimed in claim 11, wherein the noise signal from the first signal generator is recorded on the basis of a thought predefined to the person in step cb) over a predefined period of time after the thought has been predefined.

17. The method as claimed in claim 11, wherein the mathematical processing of the averaged noise signal obtained in step cc) and/or dc) comprises representing the obtained curve as a multidimensional vector.

18. The method as claimed in claim 11, wherein, in step a), a first signal generator is provided, which signal generator is provided with at least two components which have a noise signal and are operatively connected via a differential amplifier in such a manner that the noise signals from the at least two components are combined to form one noise signal.

19. A contactless man-machine interface, in particular for carrying out the method as claimed in claim 11, comprising:
at least one first signal generator which is provided with at least one component having a noise signal;
a calibration and evaluation unit comprising
at least one second signal generator which provides an optical, acoustic or haptic signal which can be perceived by the person;
at least one electronic data processing system for
gathering, processing and storing signals from the first signal generator;
controlling or regulating a machine on the basis of signals from the first signal generator.

20. The contactless man-machine interface as claimed in claim 19, wherein the first signal generator is provided with at least two components which have a noise signal and are operatively connected via a differential amplifier in such a manner that the noise signals from the at least two components are combined to form one noise signal.
